(19) United States
(12) Patent Application Publication
(10) Pub. No.: US 2025/0092980 A1
(43) Pub. Date: Mar. 20, 2025

(54) PIPE INSTALLATION SYSTEM

(71) Applicant: D'Allessandro Corporation, West Bridgewater Street, MA (US)

(72) Inventors: Jon D'Allessandro, Hingham, MA (US); Skip Martin, Kingston, MA (US)

(21) Appl. No.: 18/622,470

(22) Filed: Mar. 29, 2024

Related U.S. Application Data
(60) Provisional application No. 63/583,184, filed on Sep. 15, 2023.

(51) Int. Cl. F16L 55/16; F16L 55/1645

(52) U.S. Cl. CPC F16L 55/1608; F16L 55/1612; F16L 55/1645

(57) ABSTRACT

A pipe installation system includes a plug assembly, an installation head, a driver assembly, and a grout supply line. The installation head has a leading portion extending along a central axis, a mating portion which mates with a new pipe, a grout ejection port positioned within the leading portion, and a grout conduit connected to the grout ejection port. The leading portion has a tapered nose that extends from a first end to a maximum cross-section portion. The grout ejection port is positioned no further rearward than the maximum cross-section portion of the leading portion. The cross-section of the first end is smaller than a cross-section of the plug assembly. The cross-section of the maximum cross-section portion is at least as big as the cross-section of the plug assembly.

### CROSS-REFERENCE TO RELATED APPLICATION

This application claims priority to and the benefits of U.S. Provisional Application No. 63/583,184, filed on Sep. 15, 2023, the entire contents of which are hereby incorporated by reference.

### FIELD OF THE INVENTION

The present invention relates to an improved pipe installation system and method. More specifically, the present invention relates to an improved system that replaces an in-ground pipe and encapsulates remnants of the pipe.

### BACKGROUND OF THE INVENTION

Asbestos cement (AC) pipes and other pipes placed in the ground are problematic to replace when damaged or eroded due to environmental and health concerns. Prior proposals to replace AC pipes and install new pipes have included splitting apart AC pipes and encapsulating the pieces of the AC pipes with certain material while pulling a new pipe as a replacement. Nevertheless, the present disclosure describes novel tooling and methodologies that improve upon prior tooling and methodologies.

### SUMMARY OF THE INVENTION

The present disclosure provides, in one aspect, a pipe installation head configured to install a new pipe within an in-ground pipe. The pipe installation head includes a leading portion, a mating portion, a grout ejection port, and a grout conduit. The leading portion extends along a central axis. The leading portion has a cross-section with a tapered nose in which the cross-section increases in a rearward direction from a first end to a maximum cross-section portion. The mating portion is rearward of the leading portion and is configured to mate with the new pipe. The grout ejection port is positioned within the leading portion and is configured to eject a grout between an exterior of the pipe installation head and an interior of the in-ground pipe. The grout conduit has a connection port configured for attachment with a grout supply line. The grout conduit is configured to supply a grout from the connection port to the grout ejection port. The grout ejection port is positioned no further rearward than the maximum cross-section portion of leading portion.

The present disclosure provides, in another aspect, a pipe installation system configured to install a new pipe within an in-ground pipe. The system includes a driver assembly, a plug assembly, an installation head, a grout supply line, and a coupling assembly. The driver assembly includes a rod and is configured to move at least a portion of the pipe installation system through the in-ground pipe. The plug assembly is positioned on the rod. The installation head has a leading portion extending along a central axis, a mating portion configured to mate with the new pipe, a grout ejection port positioned within the leading portion, and a grout conduit connected to the grout ejection port to deliver a fluid grout to the port. The leading portion has a cross-section with a tapered nose in which the cross-section increases in a rearward direction from a first end to a maximum cross-section portion. The grout supply line is configured to supply a grout to the installation head. The grout supply line is attached to the grout conduit by a connection port. The coupling assembly is positioned between the first end of the leading portion and the plug assembly. The grout ejection port is positioned no further rearward than the maximum cross-section portion of the leading portion. A cross-section of the first end of the leading portion is smaller than a cross-section of the plug assembly. The cross-section of the maximum cross-section portion of the leading portion is at least as big as the cross-section of the plug assembly.

The present disclosure provides, in another aspect, a pipe installation system configured to install a new pipe within an in-ground pipe. The system includes a plug assembly, an installation head, a driver assembly, and a grout supply line. The installation head has a leading portion extending along a central axis, a mating portion configured to mate with the new pipe, a grout ejection port positioned within the leading portion, and a grout conduit connected to the grout ejection port to deliver a fluid grout to the port. The leading portion has a cross-section with a tapered nose in which the cross-section increases in a rearward direction from a first end to a maximum cross-section portion. The grout supply line is configured to supply a grout to the installation head. The grout supply line is attached to the grout conduit by a connection port. The grout ejection port is positioned no further rearward than the maximum cross-section portion of the leading portion. A cross-section of the first end of the leading portion is smaller than a cross-section of the plug assembly. The cross-section of the maximum cross-section portion of the leading portion is at least as big as the cross-section of the plug assembly.

The present disclosure provides, in another aspect, a method of installing a new pipe within an in-ground pipe. The method includes positioning a plug assembly and an installation head in the in-ground pipe, driving the installation head in a forward direction through a portion of the in-ground pipe, creating a pressurized zone between the plug assembly and a maximum cross-section portion of the leading portion of the installation head, ejecting a grout into the pressurized zone between an exterior of the installation head and an interior of the in-ground pipe during the driving of the installation head, and positioning the new pipe within the in-ground pipe. The installation head extends along a central axis and includes a leading portion having a tapered nose and a mating portion mated with the new pipe. The grout is ejected from a grout ejection port positioned within the leading portion of the installation head.

Other features and aspects of the invention will become apparent by consideration of the following detailed description and accompanying drawings.

### BRIEF DESCRIPTION OF THE DRAWINGS

FIG. 1A is a cross-section of an AC pipe positioned in the ground taken along line 1A in FIG. 2.

FIG. 1B is a cross-section of a pipe installation system according to an embodiment of the disclosure breaking the AC pipe, as taken along line 1B in FIG. 2.

FIG. 1C is a cross-section of a new pipe installed in the ground using the pipe installation system, as taken along the line 1C of FIG. 2.

FIG. 2 is a schematic of a pipe installation system in use according to an embodiment of the present disclosure.

FIG. 3 is a top view of the pipe installation system of FIG. 2.

FIG. 4 is a front perspective view of the pipe installation system of FIG. 2.

FIG. 5 is a rear perspective view of an installation head of the pipe installation system of FIG. 2.

FIG. 6A is a side view of the installation head of FIG. 5.

FIG. 6B is a side view of the installation head of FIG. 5.

FIG. 7 is another schematic view of the pipe installation system of FIG. 2 during use on a span of in-ground pipe.

FIG. 8 is a flow chart illustrating a method of installing a pipe according to an embodiment of the present disclosure.

FIG. 9 is side view of an installation head of the pipe installation system of FIG. 2, according to another embodiment of the present disclosure.

FIG. 10 is a cross-section view taken along the central axis of an installation head of the pipe installation system of FIG. 2, according to yet another embodiment of the present disclosure.

FIG. 11 is another cross-section view of the installation head of FIG. 10 taken in a direction perpendicular to the central axis.

FIG. 12 is a flow chart illustrating a method for manufacturing an installation head according to an embodiment of the present disclosure.

FIG. 13 is a schematic of a pipe installation system according to yet another embodiment of the present disclosure.

FIG. 14 is a flow chart illustrating a method of installing a pipe according to an embodiment of the present disclosure.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

The present disclosure describes an improved pipe installation system and an improved method for replacing an in-ground pipe with a new pipe. As discussed in detail below, an improved pipe installation head has a leading portion and a mating portion. The leading portion includes a tapered head that expands in a rearward direction, a maximum cross-section portion, cutting fins, and a grout ejection port positioned no further rearward than the maximum cross-section portion. The location of the grout ejection port allows the in-ground pipe to be at least partially covered in a grout before the in-ground pipe is burst and/or before the new pipe is installed. The grout is supplied to the installation head by supply lines that extend rearward from the installation head to prevent the supply lines from damage if the in-ground pipe collapses. The grout at least partially hardens after it is applied ultimately to completely encapsulate the fragmented pipe pieces from the in-ground pipe. The pipe installation system further includes a plug assembly. The plug assembly and the installation head create a pressurized zone that extends therebetween. The pressurized zone prevents the in-ground pipe from collapsing before or after the in-ground pipe is burst. The ejection ports eject the grout into the pressurized zone to prevent the grout from filling the in-ground pipe before it is burst and to ensure that the fragmented pipe pieces are encapsulated by the grout. The cutting fins can be removed from the leading portion of the pipe installation head such that the installation head can be used to slip line the in-ground pipe with the new pipe.

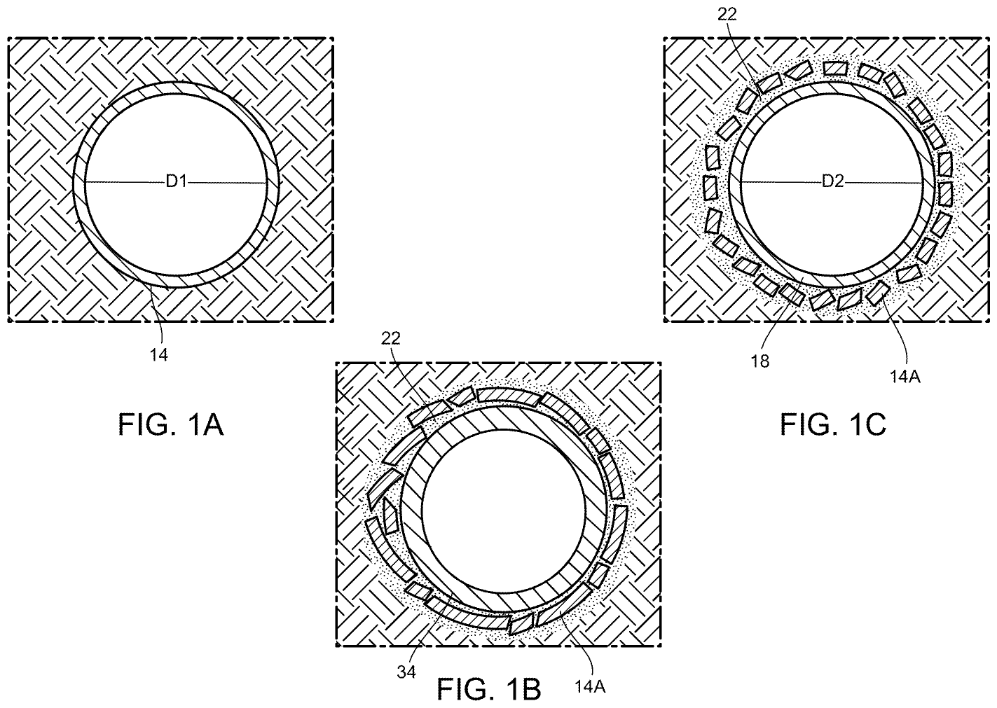

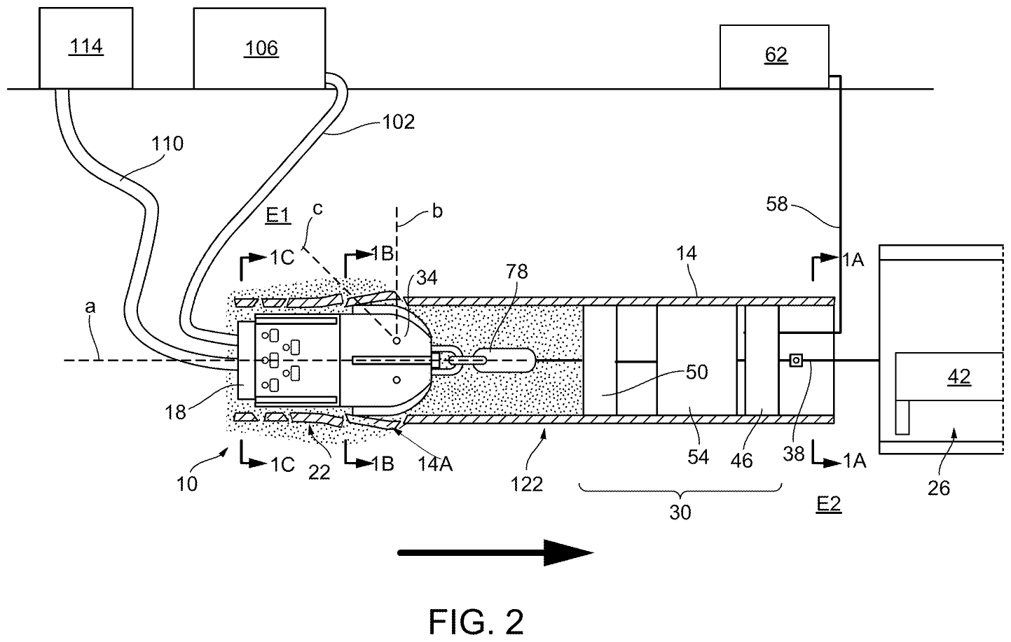

FIGS. 1A-8 illustrate an improved pipe installation system 10 and a pipe installation method 300. With reference to FIGS. 1A-2, the improved pipe installation system 10 (FIG. 2) is used to replace an in-ground, old, asbestos cement pipe 14 by installing a new pipe 18 (e.g., HDPE pipe) inside the in-ground pipe 14. As such, the pre-existing, in-ground pipe 14 need not be excavated and/or removed from the ground at significant expense. In some embodiments, the pipe installation system 10 may split the in-ground pipe 14 into fragmented pipe pieces 14A and install the new pipe 18 within the space previously occupied by the in-ground pipe 14. The pipe installation system 10 encapsulates or encases the fragmented pipe pieces 14A of the in-ground pipe 14 with a grout 22. The grout 22 separates the new pipe 18 from the fragmented pipe pieces 14A to prevent the asbestos or asbestos dust from contaminating the ground or the new pipe 18. Preferably, the grout 22 completely encapsulates the fragmented pipe pieces 14A. In some embodiments, the pipe installation system 10 may slip line the in-ground pipe 14 with the new pipe 18. In a slip lining embodiment, the grout 22 at least partially fills the annular space of the in-ground pipe 14 to act as a lubricant to help move the new pipe 18 through the in-ground pipe 14. The grout 22 may or may not harden thereafter. The grout 22 fills the annular space between the in-ground pipe 14 and the new pipe 18 to support the new pipe 18. Although this disclosure focuses on replacing in-ground AC pipes, the pipe installation system 10 and the pipe installation method 300 may be used to replace or repair other types of in-ground pipes. For example, in some embodiments, the pipe installation system 10 may be used in conjunction to excavate and repair damaged sections of a sewer piping system.

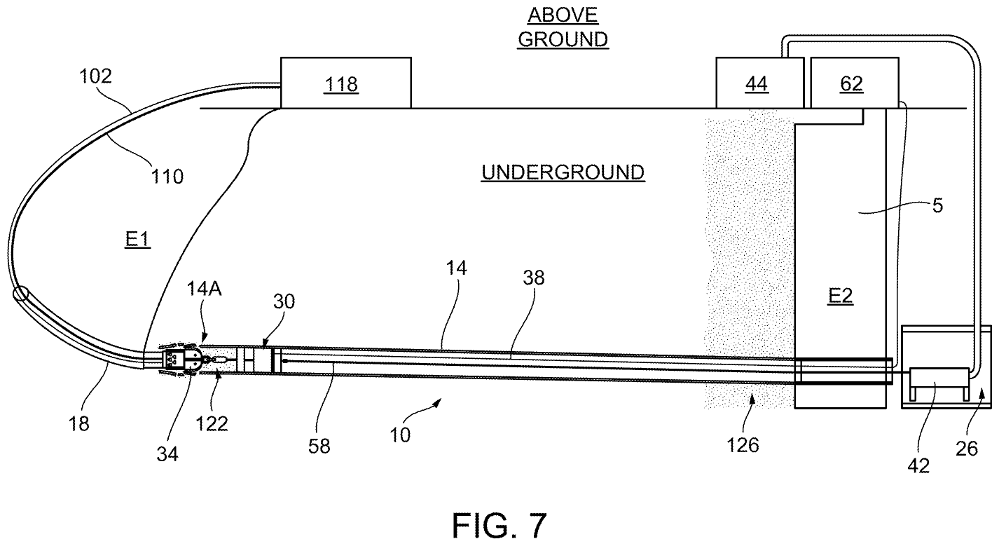

The pipe installation system 10 is used to replace a portion of an in-ground pipe 14. The portion of the in-ground pipe 14 that is being replaced spans from a first end E1 (FIG. 2) to a second end E2 (FIG. 2). In some embodiments, the portion of the in-ground pipe 14 being replaced may be the entire length of the in-ground pipe 14. In some embodiments, the first end E1 of the in-ground pipe 14 may be uphill of the second end E2 of the in-ground pipe 14. In some embodiments, like the embodiment shown in FIG. 7, the first end E1 of the in-ground pipe 14 may be accessed through a side of a hill. In some embodiments, like the embodiment shown in FIG. 7, the second end E2 of the in-ground pipe 14 may be accessed through a manhole 5. In some embodiments, both the first end E1 and the second end E2 can be accessed through a side of a hill. In some embodiments, both the first end E1 and the second end E2 can be accessed through respective manholes.

FIG. 1A illustrates the old, in-ground pipe 14 positioned in the ground. FIG. 1A is a cross-section of the pipe installation system 10 (FIG. 2) taken along the line 1A. The in-ground pipe 14 has a maximum inner diameter of D1. The soil surrounding the in-ground pipe 14 may be sand, clay, silt soil, gravel, rock soil, or any other type of ground soil or material. In embodiments where the second end E2 of the in-ground pipe 14 is accessed through the manhole 5 (FIG. 7), a soil stabilization material 126 (FIG. 7) is added to the soil at the second end E2 of the in-ground pipe 14. The soil stabilization material 126 is added to the outside of the in-ground pipe 14. The soil stabilization material 126 prevents the fragmented pipe pieces 14A (FIG. 7) from being pulled into the manhole 5. The soil stabilization material 126 may also prevent ground water from infiltrating the in-ground pipe 14. The soil stabilization material 126 may be a cementitious material or a polymer.

FIG. 1B is a cross-section of the pipe installation system 10 (FIG. 2) taken along the line 1B in FIG. 2. FIG. 1B illustrates the pipe installation system 10 after the grout 22 is ejected and after the in-ground pipe 14 (FIG. 1A) has been spilt into fragmented pipe pieces 14A but before the new pipe 18 (FIG. 1C) is positioned within the in-ground pipe 14.

The grout 22 is a cementitious grout and is configured to at least partially harden or solidify after it is ejected. More specifically, the grout 22 is a premixed non-expanding cementitious grout. The grout 22 (a) acts as a lubricant before hardening to help move the new pipe 18 (FIG. 1C) through in-ground pipe 14 (FIG. 1A), (b) is used to encapsulate the fragmented pipe pieces 14A to prevent the spread of asbestos, and (c) is used to separate the new pipe 18 from the in-ground pipe 14. This avoids the need to supply separate materials for lubrication and encapsulation. In some alternate embodiments, the grout 22 may be, for example, a foam concentrate, a cellular concrete, a chemical gel, a polymer, a polyurethane, an epoxy, or a resin. In some embodiments, the grout 22 may be an environmentally and aquatic safe substance. In some embodiments, the grout 22 may include a color dye to indicate that the grout 22 is suspending asbestos-containing material. The type of grout 22 used may depend on the type of soil (e.g., depth of the soil, the water content of the soil, and the particle size of the soil) of the ground surrounding the in-ground pipe 14.

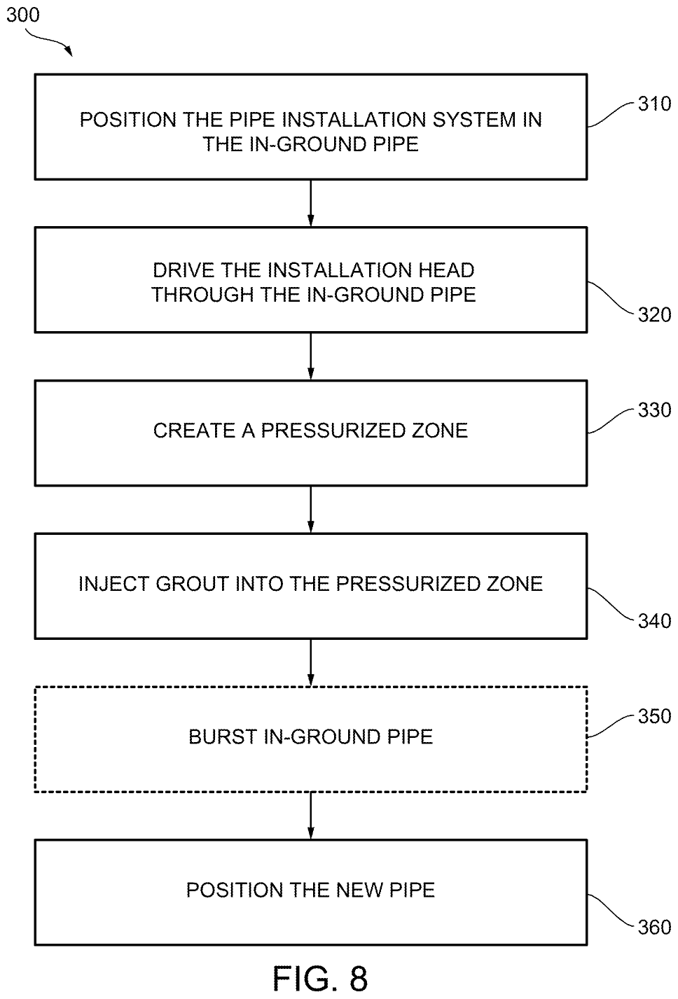

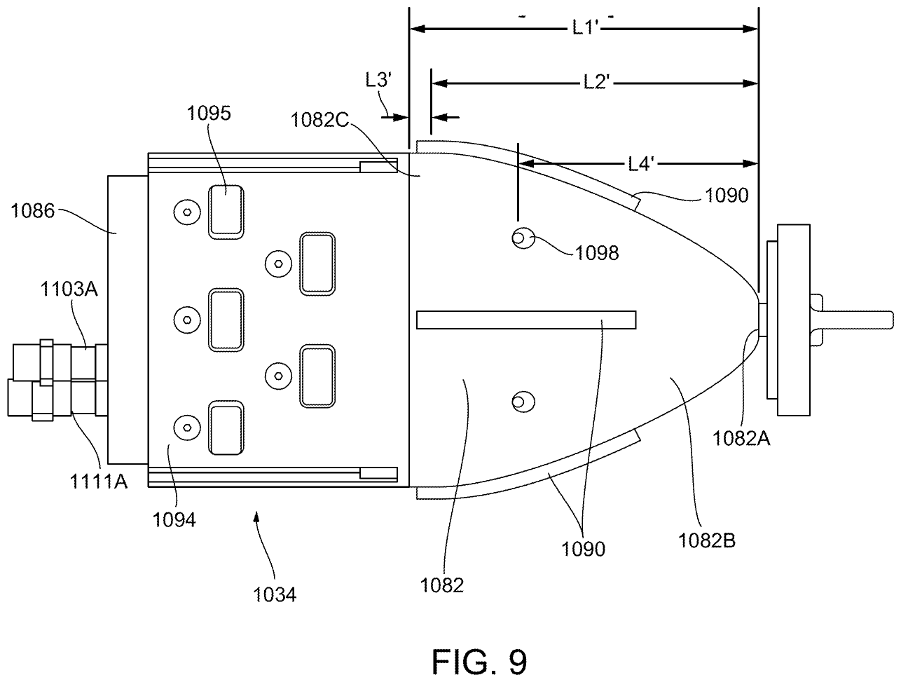

FIG. 1C illustrates the new pipe 18 that was installed to replace the old, in-ground pipe 14 with the pipe installation system 10 (FIG. 2) and the pipe installation method 300 (FIG. 8). FIG. 1C is a cross-section of the pipe installation system 10 taken along the line 1C in FIG. 2. Once the pipe installation method 300 is complete, the in-ground pipe 14 (FIG. 1A) is replaced with the new pipe 18 and the fragmented pipe pieces 14A of the in-ground pipe 14 are encapsulated by the grout 22. The new pipe 18 has an inner diameter D2. The inner diameter D2 of the new pipe 18 may be smaller, larger, or the same size as the inner diameter D1 (FIG. 1A) of the in-ground pipe 14.

With reference to FIG. 2, the pipe installation system 10 includes a driver assembly 26, a plug assembly 30, an installation head 34, and a coupling assembly 78. The driver assembly 26 is shown as a pull assembly at or near the downstream or second end E2 of the in-ground pipe 14. In other embodiments, not shown, the orientation can be reversed such that the driver assembly is a push assembly. Although the below description refers to the pull assembly 26, it will be understood that features described below can also apply to a system and method in which components of the pipe installation system 10 are pushed through the in-ground pipe 14. The pull assembly 26 is configured to pull at least a portion of the pipe installation system 10 through the in-ground pipe 14. More specifically, the pull assembly 26 is configured to pull the plug assembly 30, the installation head 34, and the new pipe 18 through the in-ground pipe 14 from the first end E1 to the second end E2 of the in-ground pipe 14 in a pulling direction (shown from left to right in FIG. 2). The pulling direction may also be referred to as a forward direction of the installation head 34.

The pull assembly 26 includes a pull rod 38 and a pulling machine 42. The pulling machine 42 may be a rod pulling machine, a hydraulic puller, or a cable puller. The pulling machine 42 is positioned below ground near the second end E2 of the in-ground pipe 14. In some embodiments, the pulling machine 42 may be positioned above ground at a location near the second end E2 of the in-ground pipe 14. In some embodiments, the pulling machine 42 may also be connected to a hydraulic power pack 44 (FIG. 7) that supplies power to the pulling machine 42. In some embodiments, the hydraulic power pack 44 may be located on the second end E2 of the in-ground pipe 14 above the ground. In some embodiments, the pulling machine 42 may be a cable puller and the pull rod 38 is coupled to a cable that is pulled by the pulling machine 42.

The plug assembly 30 is situated between the pulling machine 42 and the installation head 34. The plug assembly 30 is configured to create a seal in the in-ground pipe 14 and clear any debris from the in-ground pipe 14. The plug assembly 30 is positioned on the pull rod 38. The plug assembly 30 is axially fixed to the pull rod 38 to limit the axial movement of the plug assembly 30 relative to the pull rod 38. In some embodiments, the plug assembly 30 may also be rotationally fixed to the pull rod 38. The plug assembly 30 includes a first wiper 46, a second wiper 50, and an air bag 54 situated therebetween. In some embodiments, the plug assembly 30 may include fewer components. In some embodiments, the plug assembly 30 may include additional components. The additional components may serve as a back-up sealing element in case one of the other components of the plug assembly 30 fails and loses its seal.

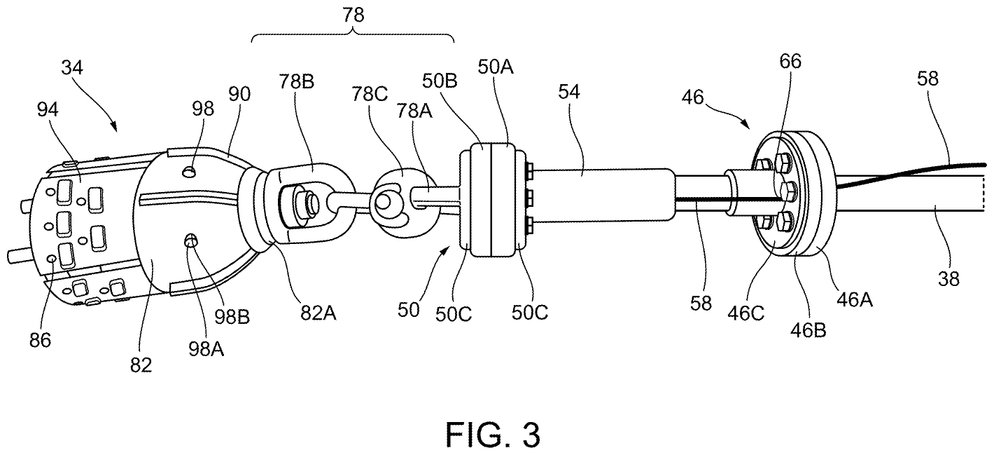

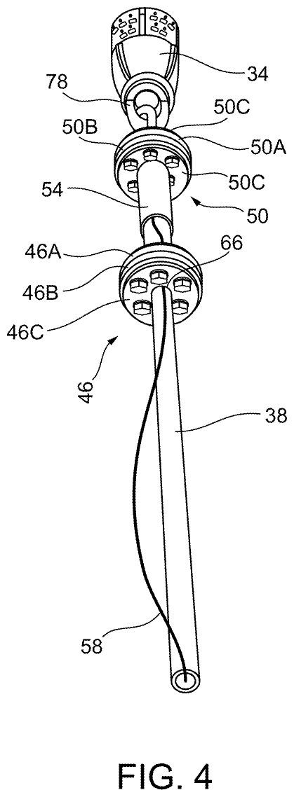

With reference to FIGS. 3 and 4, the first wiper 46 is a circular disk. The outer diameter of the first wiper 46 is the same as the inner diameter D1 of the in-ground pipe 14 (FIG. 1A). The first wiper 46 cleans the inner surface of the in-ground pipe 14 and clears the in-ground pipe 14 of any debris as the first wiper 46 is pulled through the in-ground pipe 14. The forward portion 46A is formed from rubber to create the seal in the in-ground pipe 14. The rear portion 46B is formed from a hard material such as nylon and protects the second wiper 50 if the in-ground pipe 14 collapses. The forward portion 46A and the rear portion 46B are supported between two steel plates 46C.

With continued reference to FIGS. 3 and 4, the second wiper 50 is a circular disk. The outer diameter of the second wiper 50 is the same as the inner diameter D1 of the in-ground pipe 14 (FIG. 1A). The second wiper 50 is similar to the first wiper 46 and includes a forward portion 50A and a rear portion 50B. The forward portion 50A is formed from rubber to create the seal in the in-ground pipe 14. The rear portion 50B is formed from a hard material such as nylon and protects the second wiper 50 if the in-ground pipe 14 collapses. The forward portion 50A and the rear portion 50B are supported between two steel plates 50C.

The air bag 54 is situated between the first wiper 46 and the second wiper 50. The air bag 54 is an inflatable air bag that can inflate to various sizes. The air bag 54 can be inflated such that the maximum diameter of the air bag 54 is the same as the inner diameter D1 of the in-ground pipe 14 (FIG. 1A). The air bag 54 is connected to an air compressor 62 (FIG. 2) by an air hose 58 to remotely inflate the air bag 54. The air hose 58 supplies air from the air compressor 62 to the air bag 54 to inflate the air bag 54. The air compressor 62 may be located above ground at the second end E2 of the in-ground pipe 14 (FIG. 2). In some embodiments, the air compressor 62 may be located below ground at the second end E2 of the in-ground pipe 14. With reference to FIG. 3, the air hose 58 passes through an opening 66 in the first wiper 46. The air hose 58 may be secured to a portion of the pull rod 38. For example, a zip tie may secure the air hose 58 to the pull rod 38.

With reference to FIG. 3, the coupling assembly 78 (e.g., a connection assembly) couples the installation head 34 to the plug assembly 30 (FIG. 3). The coupling assembly 78 includes a first coupling member 78A and a second coupling member 78B (e.g., a tow connection). The first coupling member 78A is positioned on the plug assembly 30. More specifically, the first coupling member 78A is positioned on the rear portion 50B of the second wiper 50. The second coupling member 78B is positioned at the installation head 34. More specifically, the second coupling member 78B is positioned at the front end of the installation head 34 (discussed more in detail below). The coupling assembly 78 may allow for some movement of the installation head 34 relative to the plug assembly 30. More specifically, the coupling assembly 78 may allow the installation head 34 to move relative to the plug assembly 30 in a direction perpendicular to the pulling direction (e.g., in an up and down direction). In the illustrated embodiment (FIG. 3), the first and second coupling member 78A, 78B are both coupled to a disk 78C situated between the first and second coupling member 78A, 78B. In some embodiments, the first coupling member 78A may be directly coupled to the second coupling member 78B.

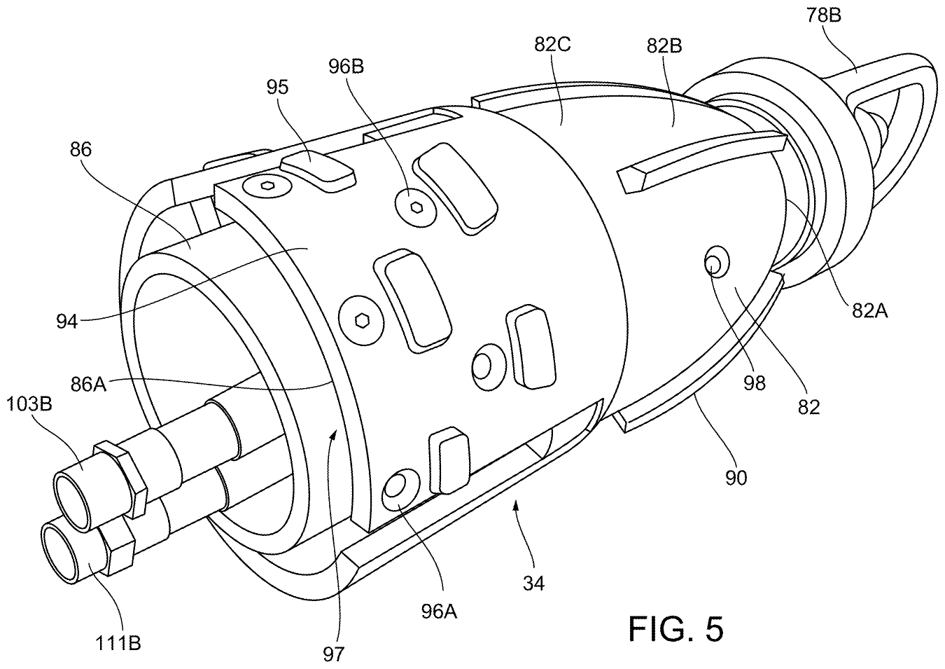

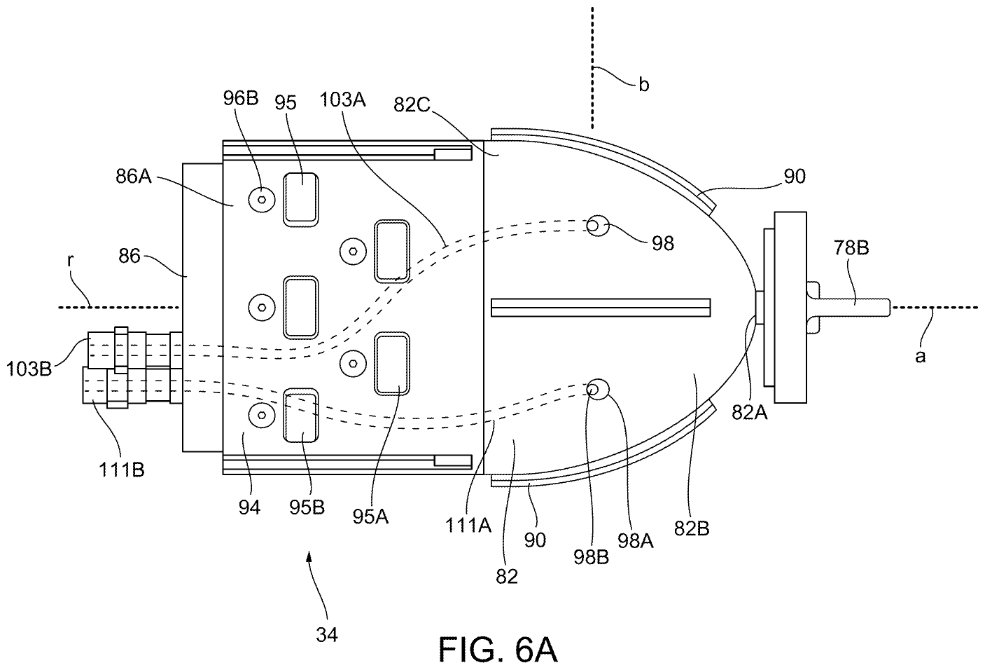

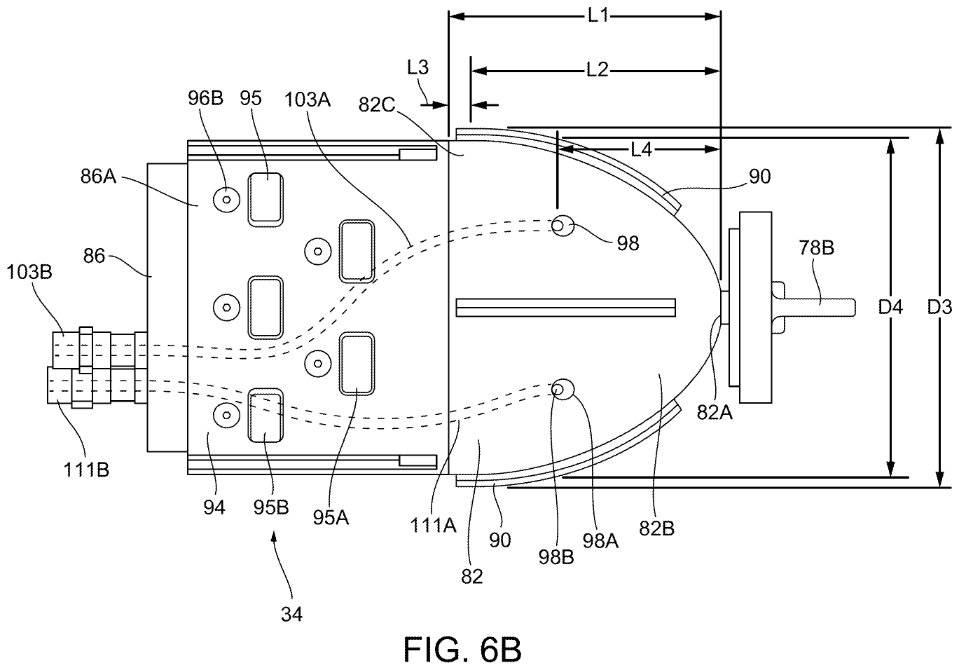

Turning to FIGS. 5-6B, the installation head 34 includes a leading portion 82 (e.g., a conical leading end, scribe end, or cutting head) and a mating portion 86 (e.g., a connection end) configured to mate with the new pipe 18 (FIG. 2). The leading portion 82 and the mating portion 86 may be formed from a hard material such as steel. The installation head 34 is integrally formed. An integrally formed head is a head that is unitarily formed from the same piece of material or a head that is formed from several elements that are permanently secured together (e.g., welded together). A head that includes elements that are removably secured or fastened together is not an integrally formed head.

The leading portion 82 extends along a central axis a (FIG. 6A). The leading portion 82 includes a front end 82A (e.g., a first end) and a tapered nose 82B. The nose is tapered along a cross section taken perpendicular to the central axis a. The tapered nose 82B defines a cross-section that increases in size in a rearward direction (e.g., from right to left in FIGS. 6A and 6B) from the front end 82A to a maximum cross-section portion 82C. The tapered nose 82B may have a circular or semi-circular cross-section. The tapered nose 82B may be frustoconical, conical, or a half dome. The maximum cross-section has a maximum outer diameter D3. The maximum outer diameter D3 of the cross-section is the diameter of a circle that contains the outermost points of the maximum cross-section portion 82C. The diameter of the front end 82A is smaller than the inner diameter D1 of the in-ground pipe 14 (FIG. 1A) and is smaller than the maximum outer diameter of the plug assembly 30 (FIG. 2). Said another way, the cross-section of the front end 82A is smaller than the interior cross-section of the in-ground pipe 14 and is smaller than the maximum cross-section of the plug assembly 30. The diameter D3 of the maximum cross-section portion 82C is at least as big as the maximum outer diameter of the plug assembly 30. Said another way, the cross-section of the maximum cross-section portion 82C is at least as big as a maximum cross-section of the plug assembly 30. In the illustrated embodiment, the diameter D3 of the maximum cross-section portion 82C is larger than the inner diameter D1 of the in-ground pipe 14 and larger than the maximum outer diameter of the plug assembly 30. Said another way, the cross-section of the maximum cross-section portion 82C is larger than the interior cross-section of the in-ground pipe 14 and larger than the maximum cross-section of the plug assembly 30. In embodiments where the pipe installation system 10 is used for slip lining without fracturing the in-ground pipe 14, the diameter D3 of the maximum cross-section portion 82C is the same as or smaller than the inner diameter D1 of the in-ground pipe 14. Said another way, the cross-section of the maximum cross-section portion 82C is the same size as or smaller than the interior cross-section of the in-ground pipe 14.

Returning to FIG. 2, the plug assembly 30 and the installation head 34 create a pressurized zone 122 (e.g., a demolition zone or a pressurized injection zone) within the in-ground pipe 14 that extends between the plug assembly 30 and the installation head 34. More specifically, the plug assembly 30 and the leading portion 82 of the installation head 34 create the pressurized zone 122. Even more specifically, the second wiper 50 and the maximum cross-section portion 82C of the leading portion 82 of the installation head 34 create the pressurized zone 122 therebetween. The pressurized zone 122 prevents the in-ground pipe 14 from collapsing and facilitates the grout covering the original in-ground pipe or its remnants.

With reference to FIGS. 5-6B, the leading portion 82 may include a plurality of radially-projecting fins 90 (e.g., cutting fins or cutting heads). The plurality of radially-projecting fins 90 extend at least partially between the front end 82A and the maximum cross-section portion 82C of the leading portion 82 and are formed from a hard material (e.g., steel). The plurality of radially-projecting fins 90 are configured to burst or split the in-ground pipe 14 (FIG. 2) into fragmented pipe pieces 14A (FIG. 2) as the installation head 34 is pulled through the in-ground pipe 14. The plurality of radially-projecting fins 90 burst the in-ground pipe 14 in the pressurized zone 122 (FIG. 2). In the illustrated embodiment, the plurality of radially-projecting fins 90 are spaced from the front end 82A and the maximum cross-section portion 82C of the leading portion 82 such that the plurality of radially-projecting fins 90 only extend along a portion of the leading portion 82 between the front end 82A and the maximum cross-section portion 82C. In some embodiments, the plurality of radially-projecting fins 90 may extend along a majority of the length between the front end 82A and the maximum cross-section portion 82C of the leading portion 82. In the illustrated embodiment (FIG. 5), the leading portion 82 includes four fins that are equally spaced around outer surface of the leading portion 82. In some embodiments, the leading portion 82 may include fewer or more fins. In some embodiments, the plurality of radially-projecting fins 90 may be integrally formed with the leading portion 82. In some embodiments, the plurality of radially-projecting fins 90 may be removably coupled to the leading portion 82 of the installation head 34. As such, the installation head 34 can be convertible and either configured for installing a new pipe with pipe bursting or configured for slip lining, without pipe bursting. In some embodiments, other methods or cutting heads can be used to split or burst the in-ground pipe 14. In some embodiments, for example, when the pipe installation system 10 is used for slip lining, the leading portion 82 may not include the plurality of radially-projecting fins 90.

With continued reference to FIGS. 5-6B, the leading portion 82 of the installation head 34 includes ejection ports 98. As described in detail below, the ejection ports 98 are configured to eject a grout or water. The ejection ports 98 are positioned within the leading portion 82 of the installation head 34. The ejection ports 98 are located at the outer periphery of the leading portion 82 that extends between the radially-projecting fins 90. In the illustrated embodiment, the leading portion 82 includes four ejection ports 98. In some embodiments, the leading portion 82 may include fewer or more ejection ports 98. In the illustrated embodiment, each port in the plurality of ejection ports 98 is positioned between adjacent fins of the plurality of radially-projecting fins 90.

Each ejection port in the plurality of ejection ports 98 is located at the same axial location on the leading portion 82 (e.g., at the same position relative to the central axis a). The plurality of ejection ports 98 are located on the maximum cross-section portion 82C or forward of the maximum cross-section portion 82C. Said another way, the axial location of the plurality of ejection ports 98 is no further rearward than the maximum cross-section portion 82C of the leading portion 82. The ejection ports 98 are also located no further rearward than the radially-projecting fins 90. In some embodiments, the plurality of ejection ports 98 may be located on the tapered nose 82B such that the plurality of ejection ports 98 are located in a region of the cross section that is not constant and is changing in shape or size. In some embodiments, the plurality of ejection ports 98 may be located on the maximum cross-section portion 82C such that the plurality of ejection ports 98 are located in a bursting region. In some embodiments, the plurality of ejection ports 98 are located on the leading portion 82 where the leading portion 82 has a diameter D3 that is at least as big as the internal diameter D1 of the in-ground pipe 14 (FIG. 1A). Said another way, the plurality of ejection grouts 98 are located on the leading portion 82 where the cross-section of the leading portion 82 is at least as big as the cross-section of the in-ground pipe 14. Each grout ejection port in the plurality of ejection ports 98 is located at an axial position on the leading portion 82 where the leading portion 82 has a diameter of D4 that is between 100% to 60% of maximum diameter D3 of the leading portion 82. Said another way, the plurality of ejection ports 98 are positioned on the leading portion 82 where the cross-section of the leading portion 82 is between 100% to 60% of the cross-section of maximum cross-section portion 82C. More specifically, the diameter D4 may be 100% to 75% of the maximum diameter D3 of the leading portion 82. Said another way, the plurality of ejection ports 98 are positioned on the leading portion 82 where the cross-section of the leading portion 82 is between 100% to 75% of the cross-section of the maximum cross-section portion 82C. Even more specifically, the diameter D4 may be 95% to 80% of the maximum diameter D3 of the leading portion 82. Said another way, the plurality of ejection ports 98 are positioned on the leading portion 82 where the cross-section of the leading portion 82 is between 95% to 80% of the cross-section of the maximum cross-section portion 82C.

In some embodiments, the ejection ports 98 are integrally formed into the leading portion 82. In some embodiments, the ejection ports 98 are removably coupled to the leading portion 82. In such embodiments, the leading portion 82 may include threaded openings 98A (FIG. 3) into which a port plug 98B (FIG. 3) may be threaded. The removeable ejection ports 98, formed by the threaded openings 98A and the port plugs 98B, allow the user (1) to replace the port plugs 98B due to wear; (2) to change the size of the ejection port 98; or (3) to change the direction the ejection ports 98 are aimed. A user may choose the size of the ejection port or the direction that the ejection port is aimed depending on the type of soil in the ground surrounding the in-ground pipe 14 (FIG. 2).

At least some of the ejection ports 98 are configured to eject the grout 22 (FIG. 2) to encapsulate the in-ground pipe 14. The ejection ports 98 are configured to inject the grout 22 into the pressurized zone 122 and between the exterior of the installation head 34 and the interior of the in-ground pipe 14 to encapsulate the in-ground pipe 14. The ejection ports 98 are aimed in a direction c (FIG. 2) that is between a radially outward direction b that is perpendicular to the central axis a and an axially rearward direction r that is parallel to the central axis a. In some embodiments, the ejection ports 98 are aimed at the front end 82A of the leading portion 82 such that the ejection ports 98 eject the grout 22 toward the front end 82A. In some embodiments, the ejection ports 98 are aimed in the rearward direction r such that the ejection ports 98 eject the grout 22 in the rearward direction r toward the mating portion 86. In some embodiments, the ejection ports 98 are aimed in the radially outward direction b such that the ejection ports 98 eject the grout 22 in the radially outward direction b. The aim direction of each ejection port in the plurality of ejection port 98 can be adjusted without removing the individual ejection port from the leading portion 82. For example, the aim direction of an individual ejection port can be adjusted by rotating the ejection port relative to the central axis a. In some embodiments, all the ejection ports 98 eject the grout 22. In some embodiments, some ejection ports 98 eject the grout 22 and some ejection ports 98 eject water.

With reference to FIGS. 2 and 6A, the ejection ports 98 that eject the grout 22 are connected to a grout supply line 102. The grout supply line 102 delivers the grout 22 from a grout tank 106 to at least one of the ejection ports 98. The grout supply line 102 or the grout tank 106 may include a pump that is configured to move the grout 22 along the grout supply line 102. In some embodiments, the pump has a pressure between 1 and 1000 PSI. In some embodiments, the pump has a pressure between 1 and 500 PSI. In some embodiments, the pump has a pressure between 100 and 300 PSI. In a preferred embodiment, the pump has a pressure between 100 PSI and 150 PSI.

The grout tank 106 may be positioned above ground at the first end E1 of the in-ground pipe 14. The grout supply line 102 extends through the new pipe 18 to connect with the ejection ports 98. The ejection ports 98 are connected to the grout supply line 102 by a grout conduit 103A (FIG. 6A). The grout conduit 103A extends from the mating portion 86 to the leading portion 82 to connect to at least one of the grout ejections ports 98. The grout supply line 102 attaches to the grout conduit 103A at a grout connection port 103B. The grout connection port 103B is located near the trailing end 86A of the installation head 34. In some embodiments, the grout connection port 103B may include an internal thread such that the grout supply line 102 is threaded into the grout connection port 103B. In some embodiments, a coupler ring may secure the grout supply line 102 to the grout connection port 103B.

With continued reference to FIGS. 2 and 6A, the ejection ports 98 that eject water are fluidly connected to a water supply line 110. The water supply line 110 may deliver water from a water tank 114 to at least one of the ejection ports 98. The water supply line 110 or the water tank 114 may include a pump that is configured to move the water along the water supply line 110. In some embodiments, the pump has a pressure between 1 and 1000 PSI. In some embodiments, the pump has a pressure between 1 and 500 PSI. In some embodiments, the pump has a pressure between 100 and 300 PSI. In a preferred embodiment, the pump has a pressure between 100 PSI and 150 PSI.

The water tank 114 may be positioned above ground at the first end E1 of the in-ground pipe 14. The water supply line 110 extends through the new pipe 18 to connect with the ejection ports 98, and the ejection ports 98 are fluidly connected to the water supply line 110 by a water conduit 111A. The water conduit 111A extends from the mating portion 86 to the leading portion 82 to connect to at least one of the ejections ports 98. The water supply line 110 attaches to the water conduit 111A at a water connection port 111B. The water connection port 111B is located near the trailing end 86A of the installation head 34. In some embodiments, the water connection port 111B may include an internal thread such that the water supply line 110 is threaded into the water connection port 111B. In some embodiments, a coupler ring may secure the water supply line 110 to the water connection port 111B.

In some embodiments, the grout 22 may be premixed with water in a mixing tank 118 (FIG. 7) and all the ejection ports 98 eject the premixed grout 22. The mixing tank 118 is positioned above ground at the first end E1 of the in-ground pipe 14. The mixing tank 118 is connected to the ejection ports 98 by the grout supply line 102. In the illustrated embodiment, the ejection ports 98 are also connected to the mixing tank 118 by the water supply line 110. The water supply line 110 may provide additional water to the premixed grout 22 to dilute the premixed grout 22. In some embodiments, the ejection ports 98 are connected only to the grout supply line 102 and there is no additional water supply line. In some embodiments, the mixing tank 118 mixes water, grout, and at least one additive to form the premixed grout 22.

With reference to FIG. 6B, the leading portion 82 has a total length of L1. The length L2 defines the length of the tapered nose 82B. In the illustrated embodiment, the length L2 is less than the total length L1. The length L3 defines the length of the maximum cross-section portion 82C. In the illustrated embodiment, the length L3 is smaller than the length L2 such that the majority of the leading portion 82 is defined by the tapered nose 82B. The length L4 defines the length from the front end 82A to the axial location of the ejection ports 98. In some embodiments, the length L4 is at least half the length of L2. In some embodiments, the length L4 is at least 65% of the length of L2. In some embodiments, the length L4 is the same as the length L2.

With reference to FIGS. 5-6B, the mating portion 86 is rearward of the leading portion 82 and adjacent to the maximum cross-section portion 82C of the leading portion 82. The cross-section of the mating portion 86 is generally circular. In the illustrated embodiment, the mating portion 86 has a constant cross-section. In some embodiments, the mating portion 86 may have a decreasing cross-section or a varying cross-section. In the illustrated embodiment, the mating portion 86 has a diameter that is the same as the maximum diameter D3 of the maximum cross-section portion 82C. In some embodiments, the mating portion 86 may have a smaller diameter than the maximum diameter D3 of the leading portion 82.

The mating portion 86 includes a trailing end 86A that is configured to mate with the new pipe 18. The trailing end 86A includes a pipe fitting 94. The pipe fitting 94 forms a pipe receiving space 97 between the mating portion 86 and the pipe fitting 94 that is configured to receive the new pipe 18 (FIG. 2). The pipe fitting 94 includes openings 96A that are configured to receive a fastener 96B. The fastener 96B may be a threaded fastener. The fastener 96B secures the new pipe 18 in the receiving space 97 (FIG. 5) such that the installation head 34 pulls the new pipe 18 as the installation head 34 moves through the in-ground pipe 14 (FIG. 2). In some embodiments, the trailing end 86A may include a different type of pipe fitting (e.g., a collar).

The mating portion 86 further includes a plurality of bosses 95. In the illustrated embodiment, the bosses 95 are hard rectangular pieces that are welded to the mating portion 86. The bosses 95 are formed from a hardened steel. The bosses 95 have a height (e.g., the amount of extension in the radially outward direction b (FIG. 2)) that is smaller than the maximum height of the fins 90. In some embodiments, the bosses 95 have a triangular, square, or a pentagonal shape. The leading surfaces of the bosses 95 are generally flat. In some embodiments, the bosses 95 are removably coupled to the mating portion 86 such that the bosses 95 can be replaced if they begin to wear. In alternative embodiments, the bosses 95 have a height that is the same as maximum height of the fins 90. In other alternative embodiment, the bosses 95 have a height that is larger than the maximum height of the fins 90.

A first portion 95A of the bosses 95 are arranged in a front or leading row and a second portion 95B of the bosses 95 are arranged in rear or trailing row. The second portion 95B of the bosses 95 in the rear row are offset (e.g., staggered) from the first portion 95A of bosses 95 in the front row such that the bosses 95 of the rear row occupy different angular positions than the bosses of the front row about the central axis a. The first portion 95A of the bosses 95 is offset from the plurality of radially-projecting fins 90. In some embodiments, the first portion 95A and the second portion 95B of the bosses are offset from the plurality of radially-projecting fins 90. The offset nature of bosses 95 allow the grout 22 (FIG. 2) to be mixed by the bosses 95 as the installation head 34 is pulled through the in-ground pipe 14 (FIG. 2) by disrupting the flow of the grout 22. The bosses 95 break the fragmented pipe pieces 14A (FIG. 1C) into smaller, more uniform pieces such that the grout 22 is more easily dispersed throughout the fragmented pipe pieces 14A and the fragmented pipe pieces 14A can be completely encapsulated. Additionally, the bosses 95 push the grout 22 and the fragmented pipe pieces 14A in the radially outward direction b (FIG. 2). In general, the bosses 95 facilitate the encapsulation of the fragmented pipe pieces 14A. Additionally, each of the bosses in the plurality of bosses 95 is situated in front one of the fasteners 96B to protect the fasteners 96B during the pulling operation.

FIGS. 7 and 8 describe the pipe installation method 300 using the pipe installation system 10. The pipe installation method 300 includes positioning the pipe installation system 10 in the in-ground pipe 14 (STEP 310). Positioning the pipe installation system 10 in the in-ground pipe 14 includes positioning the plug assembly 30 and the installation head 34 within the in-ground pipe 14 at the first end E1 of the in-ground pipe 14. The pipe installation system 10 is positioned such that the plug assembly 30 is forward of the installation head 34 in the direction of travel. Positioning the pipe installation system 10 may also include positioning the mixing tank 118 above ground at the first end E1 of the in-ground pipe 14, positioning the pulling machine 42 below ground at the second end E2 of the in-ground pipe 14, and positioning the air compressor 62 and the hydraulic power pack 44 above ground at the second end E2 of the in-ground pipe 14. The pull rod 38 may be coupled to the plug assembly 30 before the plug assembly 30 is positioned in the in-ground pipe 14. The grout supply line 102 may be connected to the grout conduit 103A (FIGS. 6A and 6B) and the water supply line 110 may be connected to the water conduit 111A (FIGS. 6A and 6B) before the installation head 34 is positioned in the in-ground pipe 14. The air hose 58 may be connected to the air bag 54 (FIG. 2) of the plug assembly 30 before the plug assembly 30 is positioned in the in-ground pipe 14.

Once the pipe installation system 10 is positioned in the in-ground pipe 14, the plug assembly 30 and the installation head 34 may be driven (pulled or pushed) through a portion of the in-ground pipe 14 (STEP 320). According to the illustrated embodiment, the plug assembly 30 and the installation head 34 are pulled from the first end E1 of the in-ground pipe 14 to the second end E2 of the in-ground pipe 14 in the pulling direction (shown from left to right in FIG. 7). The pressurized zone 122 is created between the plug assembly 30 and the installation head 34 (STEP 330). The pressurized zone 122 is established as the installation head 34 is driven through the in-ground pipe 14 and moves with the installation head 34 through the in-ground pipe 14.

Additionally, the grout 22 is ejected into the pressurized zone 122 (STEP 340). More specifically, STEP 340 includes injecting the grout 22 from the plurality of ejection ports 98 into the pressurized zone 122. The grout 22 is ejected from the plurality of ejection ports 98 in the direction c (FIG. 2) that is between a radially outward direction b that is perpendicular to the central axis a (FIG. 2) and an axially rearward direction that is parallel to the central axis a (FIG. 2). The grout 22 that is ejected is a pre-mixed non-expanding cementitious grout. The plug assembly 30 prevents the grout 22 from spreading outside of the pressurized zone 122. The installation head 34 helps to push the grout 22 radially outward as the installation head 34 is being pulled.

In embodiments where the in-ground pipe 14 is burst, the pipe installation method 300 may further include the optional step of bursting the in-ground pipe 14 (STEP 350). More specifically, the pipe installation method 300 may further include bursting the in-ground pipe 14 with the plurality of radially-projecting fins 90 positioned on the leading portion 82 of the installation head 34 as the installation head 34 is pulled through the in-ground pipe 14. A section of the in-ground pipe 14 is burst in the pressurized zone 122 after the grout 22 is injected therein to pressurize the pressurized zone 122. The installation head 34 may push the fragmented pipe pieces 14A of the in-ground pipe 14 radially outwards to create a space for the new pipe 18. In other pipe bursting embodiments, the in-ground pipe 14 is burst and the grout 22 is ejected from the ejection ports 98 simultaneously.

The pipe installation method 300 also includes positioning the new pipe 18 within the in-ground pipe 14 (STEP 360). The new pipe 18 may be positioned in the grout 22 and in the space created by bursting the in-ground pipe 14. The new pipe 18 is positioned such that the new pipe 18 is at least partially surrounded by the grout 22. Preferably, the new pipe 18 is positioned such that the new pipe 18 is completely surrounded by the grout 22. The grout 22 at least partially hardens to ensure that the fragmented pipe pieces 14A are completely encapsulated. Once the new pipe 18 is positioned, the new pipe 18 may be separated from the mating portion 86 (FIG. 5) of the installation head 34. More specifically, the new pipe 18 may be separated from the pipe fitting 94 (FIG. 5) by unfastening the fasteners 96B (FIG. 5).

Although the method of the pipe installation method 300 is described in sequential steps, it will be appreciated that some of the steps may be completed in a different order, some of the steps may be completed simultaneously, and some of the steps may be omitted.

In some embodiments, not shown, the pipe installation system may be a pneumatic system and method of bursting the in-ground pipe 14 and installing the new pipe 18. The pneumatic pipe installation system may include an air compressor located on the first end E1 of the in-ground pipe 14, a piston cylinder positioned inside the installation head, and a striker positioned inside the installation head. The air compressor drives the piston cylinder to reciprocate, and the piston drives the striker to transfer an impact force to the head. The impact force provided by the pneumatic system helps burst the in-ground pipe 14 and increases the amount of vibration transmitted to the surrounding soil. The increased vibration may allow for the grout 22 to be more easily dispersed throughout the soil. The above pneumatic pipe installation system is in contrast with the pipe installation system 10 and the pipe installation method 300 which describe a static pipe system and method that does not use an impact force.

FIG. 9 illustrates an installation head according to another embodiment. Installation head 1034 is similar to installation head 34 (FIGS. 6A-6B), but installation head 1034 has an elongated profile. Many of the components of installation head 1034 are similar to the components of the installation head 34. Accordingly, the preceding description and drawings are relied upon for a disclosure of the features and alternatives that might not be described in detail here.

Installation head 1034 includes a leading portion 1082 and a mating portion 1086. The leading portion 1082 has a cross-section with an elongated tapered nose 1082B and a maximum cross-section portion 1082C. The tapered nose 1082B defines a cross-section that increases in size in a rearward direction from a front end 1082A to a maximum cross-section portion 1082C. The leading portion 1082 may further include a plurality of radially-projecting fins 1090 that extend between at least partially between the front end 1082A and the maximum cross-section portion 1082C. The leading portion 1082 also includes ejection ports 1098 that are configured to eject the grout 22 (FIG. 2). At least some of the ejection ports 1098 receive grout from the grout supply line 102 via the grout conduit 1103A. Some of the ejection ports 1098 may receive water from the water supply line 110 via the water conduit 1111A. The mating portion 1086 includes a pipe fitting 1094 that is configured to receive the new pipe 18 (FIG. 2) and secure the new pipe 18 to the mating portion 1086. The mating portion 1086 includes the plurality of bosses 1095 to help facilitate the encapsulation of the fragmented pipe pieces 14A (FIG. 2) by displacing grout away from the central axis and/or breaking the pipe into smaller pieces 14A.

Compared to the installation head 34 shown in FIGS. 6A-6B, the installation head 1034 has an elongated tapered nose 1082B. The elongated tapered nose 1082B of the leading portion 1082 allows the installation head 1034 to burst the in-ground pipe 14 in a more controlled manner. The total length L1′ of the leading portion 1082 is longer than total length L1 of the leading portion 82. The length L2′ of the elongated tapered nose 1082B of the installation head 1034 is longer than the tapered nose 82B length L2 of the installation head 34. The length L3′ of the maximum cross-section portion 1082C is the same as the length L3 of the maximum cross-section portion 82C. The length L4′ between the front end 1082A and the ejection ports 1098 is longer than the length L4 between the front end 82A and the ejection ports 98.

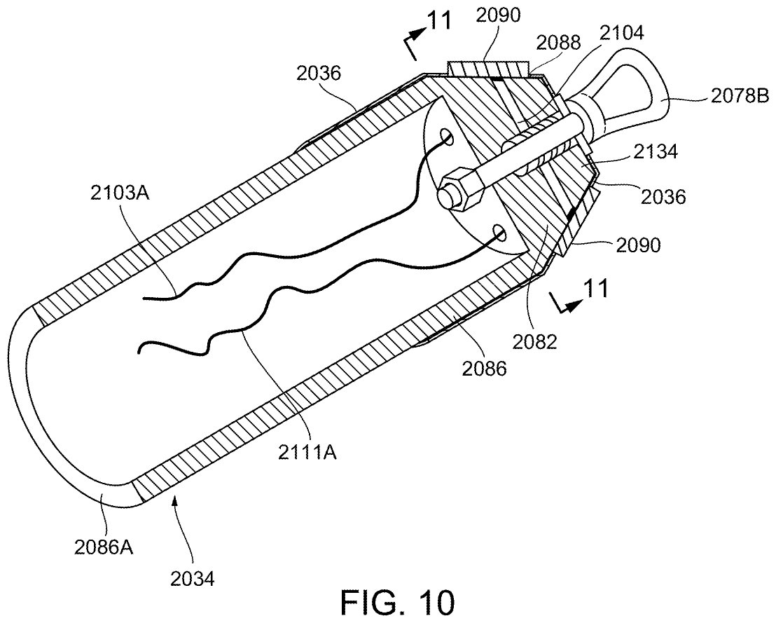

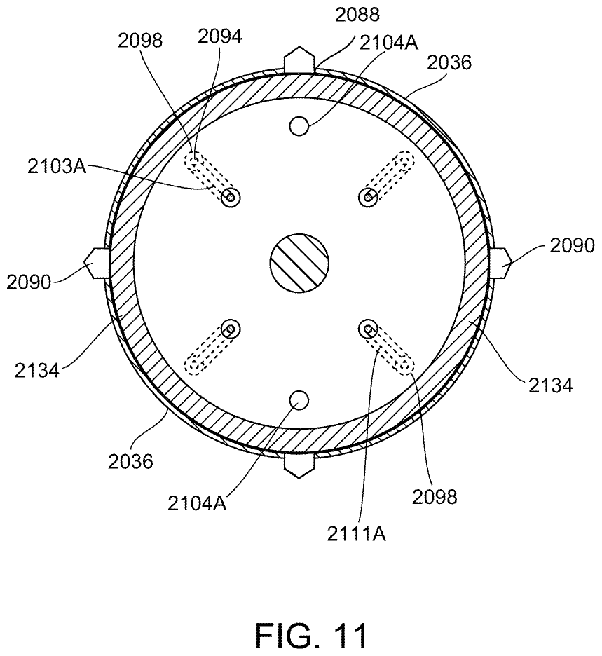

FIGS. 10-11 illustrate an installation head, such as the installation head 34 (FIGS. 6A-6B) according to another embodiment. The installation head 2034 is similar to the installation head 34, but the installation head 2034 uses an HDPE pipe head 2134 that is fused to the new pipe 18 (FIG. 2). Many of the components of the installation head 2034 are similar to the components of the installation head 34. Accordingly, the preceding description and drawings are relied upon for a disclosure of the features and alternatives that might not be described in detail here.

The installation head 2034 includes a polymer (e.g., HDPE) pipe head 2134 with a leading portion 2082 and a mating portion 2086. As one non-limiting example, the HDPE pipe head 2134 may be the PE Towing Head manufactured by Pipe Equipment Specialists LTD. The leading portion 2082 includes a tapered nose with a decreasing cross-section in the forward direction. The mating portion 2086 includes a trailing end 2086A that is configured to mate with the new pipe 18 (FIG. 2). A fuse joint (not shown) connects the trailing end 2086A of the installation head 2034 to the leading end of the new pipe 18. In some embodiments, the fuse joint directly connects the trailing end 2086A to the new pipe 18. In other embodiments, the leading end of the new pipe 18 is coupled to a pipe coupling collar, and the collar is fused to the trailing end 2086A of the installation head 2034. As one non-limiting example, the collar may be the B-Tech Connections™ manufactured by Boyd Tech. The leading end of the new pipe 18 is mechanically coupled to the collar. For example, the collar may be threaded onto the leading end of the new pipe 18 or the new pipe 18 may be bolted to the collar.

The installation head 2034 further includes a metal sheath 2036 that covers at least a portion of the HDPE pipe head 2134. More specifically, the metal sheath 2036 covers the leading portion 2082 and at least a portion of the mating portion 2086. The metal sheath 2036 protects the HDPE pipe head 2134 from damage. The metal sheath 2036 is secured to the HDPE pipe head 2134 to limit the rotation or other movement of the metal sheath 2036 relative to the HDPE pipe head 2134. In some embodiments, the metal sheath 2036 is secured to the HDPE pipe head 2134 with a weld. In some embodiments, at least one bolt secures the metal sheath 2036 to the HDPE pipe head 2134. In some embodiments, at least one screw, such as a hex screw, secures the metal sheath 2036 to the HDPE pipe head 2134. In some embodiments, the metal sheath 2036 threads onto the HDPE pipe head 2134.

The installation head 2034 may include a plurality of radially-projecting fins 2090 that are coupled to the metal sheath 2036. In the illustrated embodiment, the radially-projecting fins 2090 are removeable and the metal sheath 2036 includes receiving recesses 2088 that can receive the plurality of radially-projecting fins 2090. The receiving recesses 2088 and the radially-projecting fins 2090 may form a dove-tail joint therebetween. In some embodiments, the plurality of radially-projecting fins 2090 are welded to the metal sheath 2036. In some embodiments, the plurality of radially-projecting fins 2090 are coupled to the HDPE pipe head 2134.

The installation head 2034 includes ejection ports 2094 that are configured to eject the grout 22 (FIG. 2) or water. The ejection ports 2094 may include removeable port plugs that are positioned in openings 2098. The openings 2098 extend through the metal sheath 2036 and the leading portion 2082 of the HDPE pipe head 2134 such that the removeable port plugs 2094 and be connected to a grout conduit 2103A or a water conduit 2111A.

In the illustrated embodiment, the grout conduit 2103A and the water conduit 2111A include a circular conduit portion 2104 (e.g., a reservoir) that is fluidly connected to the ejection ports 2094. The circular conduit portion 2104 is located in the leading portion 2082 of the HDPE pipe head 2134. The circular conduit portion 2104 maintains the fluid connection with the ejection ports 2094 such that if the metal sheath 2036 and the ejection ports 2094 are rotated relative to the HDPE pipe head 2134, the ejection ports 2094 can still be supplied with the grout 22 (FIG. 2) and the water. Additionally, if one of ejection ports 2094 is clogged, the circular conduit portion 2104 allows the remaining ejection ports 2094 to still be able to eject the grout 22 and the water. The grout conduit 2103A and the water conduit 2111A reach the circular conduit portion 2104 through openings 2104A (FIG. 11) in the leading portion 2082 of the HDPE pipe head 2134. The openings 2014A are diametrically opposed. In some alternative embodiments, the grout conduit 2103A and the water conduit 2111A connect directly to ejection ports 2094.

The installation head 2034 may be coupled to a second coupling member 2078B. The second coupling member 2078B is an eye bolt and includes a shaft that extends through the metal sheath 2036 and the leading portion 2082 of the HDPE pipe head 2134. The second coupling member 2078B may secure the metal sheath 2036 to the HDPE pipe head 2134 to limit axial movement between the metal sheath 2036 and the HDPE pipe head 2134.

The installation head 2034 may also be used in the pipe installation method 300 described above. The new pipe 18 (FIG. 2) is, however, separated from the installation head 2034 by severing the fused joint between the leading end of the new pipe 18 and the mating portion 2086 of the installation head 2034. In the embodiments with the pipe coupling collar, the fused joint between the mating portion 86 and the pipe coupling collar is severed, and optionally, the new pipe 18 is uncoupled from the collar.

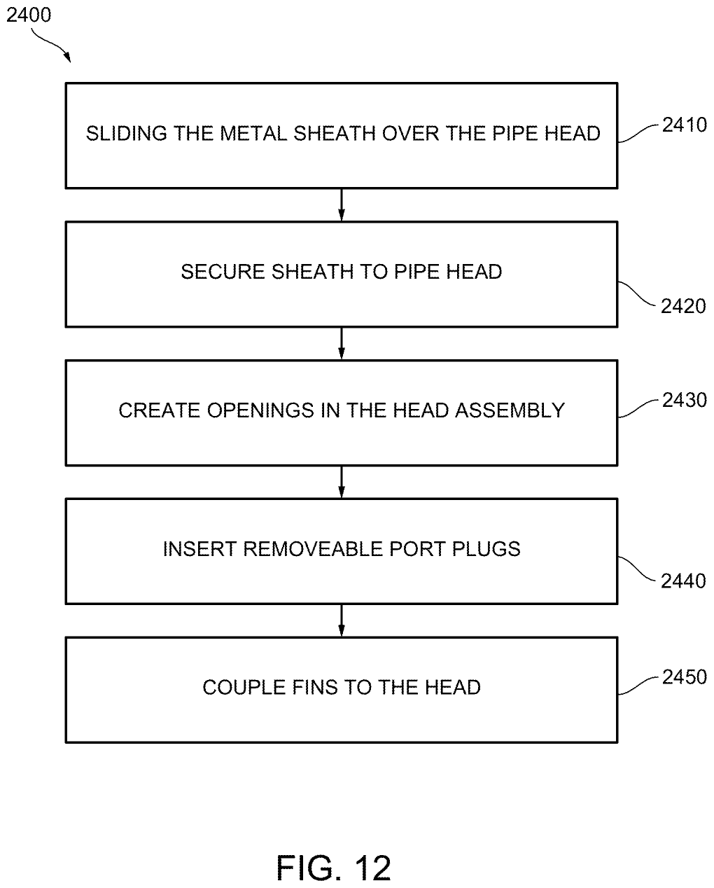

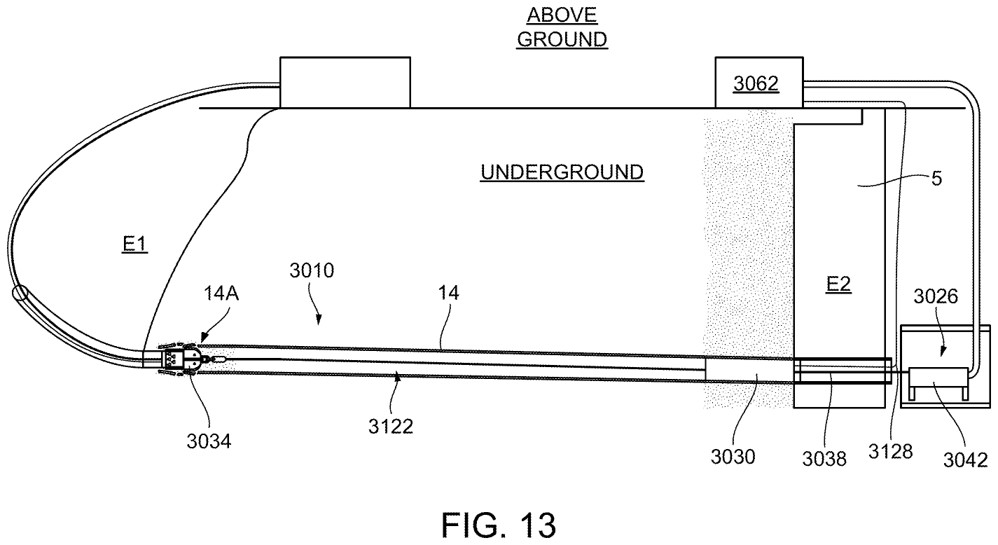

With reference to FIGS. 10 and 12, the method of manufacturing 2400 the installation head 2034 includes sliding the metal sheath 2036 over an HDPE pipe head 2134 (STEP 2410). The metal sheath 2036 is positioned around the HDPE pipe head 2134 (FIG. 10) such that the metal sheath 2036 at least covers the leading portion 2082 of the HDPE pipe head 2134. The metal sheath 2036 may be positioned such that it covers a portion of the mating portion 2086.

Once the metal sheath 2036 is positioned onto the HDPE pipe head 2134, the metal sheath 2036 is secured to the HDPE pipe head 2134 (STEP 2420). More specifically, the metal sheath 2036 is secured to the HDPE pipe head 2134 to prevent the metal sheath 2036 from rotating or otherwise moving relative to the HDPE pipe head 2134. In some embodiments, securing the metal sheath 2036 to the HDPE pipe head 2134 includes applying at least one weld between the HDPE pipe head 2134 and the metal sheath 2036. In some embodiments, securing the metal sheath 2036 to the HDPE pipe head 2134 includes bolting the metal sheath 2036 to the HDPE pipe head 2134 with at least one bolt. In some embodiments, securing the metal sheath 2036 to the HDPE pipe head 2134 includes screwing at least one screw, such as a hex screw, into the metal sheath 2036 the HDPE pipe head 2134.

Next, openings 2098 are created in the installation head 2034 (STEP 2430). The openings 2098 may be bored into the installation head 2034 such that the openings 2098 extend through the metal sheath 2036 and into the HDPE pipe head 2134. Creating the openings 2098 further includes connecting the circular conduit portion 2104 in the leading portion 2082 to the openings 2098. In some embodiments, the HDPE pipe head 2134 of the new pipe 18 and the metal sheath 2036 already include the openings 2098 such that the openings 2098 do not have to be created after the metal sheath 2036 is secured to the HDPE pipe head 2134.

After the openings 2098 are created in the installation head 2034, the removeable port plugs are inserted into the openings 2098 (STEP 2440). In some embodiments, the removeable port plugs may be threaded into the openings 2098. The removeable port plugs are inserted such that the removeable port plugs are in fluid communication with the circular conduit portion 2104. In some embodiments, the removeable port plugs are inserted such that the removeable port plugs are coupled to the grout conduit 2103A and the water conduit 2111A.

At STEP 2450 the plurality of radially-projecting fins 2090 are coupled to the installation head 2034. More specifically, the plurality of radially-projecting fins 2090 are coupled to the metal sheath 2036 near the leading portion 2082 of the HDPE pipe head 2134. The plurality of radially-projecting fins 2090 are slid into the fin receiving recesses formed in the metal sheath 2036.

Then, the second coupling member 2078B may be installed into the installation head 2034. The second coupling member 2078B may be inserted such that the extends through the metal sheath 2036 and into the installation head 2034. The second coupling member 2078B is then secured to the installation head 2034 of the second coupling member 2078B.

Although the method of manufacturing 2400 the installation head 2034 is described in sequential steps, it will be appreciated that some of the steps may be completed in a different order, some of the steps may be completed simultaneously, and some of the steps may be omitted.

Using installation head 2034, rather than installation head 34, reduces the time necessary to connect the new pipe 18 to the installation head. To connect the new pipe 18 to the installation head 34, the user must insert the leading end of the new pipe 18 into the receiving space 97 (FIG. 5) and fasten numerous fasteners 96B (FIG. 5) to secure the new pipe 18. In contrast, the user merely fuses the new pipe 18 to the mating portion 2086 of the installation head 2034. In embodiments with the pipe coupler collar, the user first attaches the collar to the leading end of the new pipe 18 and then fuses the collar to the mating portion 2086 of the installation head 2034. Using the pipe coupler collar is faster than using the fasteners 96B.

Using installation head 2034, rather than installation head 34, also reduces the time necessary to disconnect the new pipe 18 from the installation head. To remove the new pipe 18 from the installation head 34, the user must unfasten the fasteners 96B. In contrast, the user disconnects the new pipe 18 from the mating portion 2086 merely by severing the fused joint. In embodiments with the pipe coupler collar, the new pipe 18 is disconnected by first severing the fused joint and then removing the collar. In sum, using the installation head 2034 streamlines the attachment of the new pipe 18 to the installation head 2034 as well as the removal of the new pipe 18.

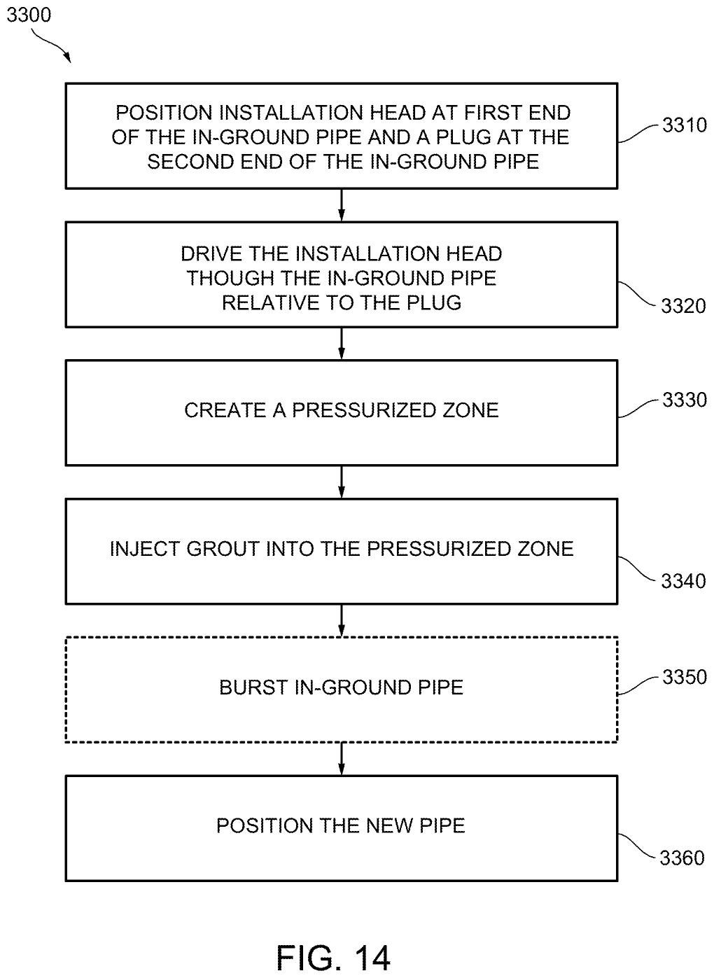

FIGS. 13-14 illustrate a pipe installation system 3010 and a pipe installation method 3300, such as the pipe installation system 10 (FIG. 7) according to another embodiment. The pipe installation system 3010 is similar to the pipe installation system 10, but pipe installation system 3010 includes a stationary plug assembly 3030. Many of the components of the pipe installation system 3010 are similar to the components of the pipe installation system 10. Accordingly, the preceding description and drawings are relied upon for a disclosure of the features and alternatives that might not be described in detail here.

The pipe installation system 3010 includes a driver (e.g., pull) assembly 3026, a plug assembly 3030, an installation head 3034, and a pressurized zone 3122. The pull assembly 3026 is similar to the pull assembly 26 of the pipe installation system 10 (FIG. 7) and includes a pulling machine 3042 and a pull rod 3038. The pulling machine 3042 is located below ground near the second end E2 of the in-ground pipe 14.

The plug assembly 3030 is positioned within the in-ground pipe 14 at the second end E2. The plug assembly 3030 is configured to remain stationary during the pipe installation process. The plug assembly 3030 may be a wiper similar to the first wiper 46 or an air bag similar to the air bag 54 (FIG. 7). The pull rod 3038 extends through the plug assembly 3030. The plug assembly 3030 may be supported on the pull rod 3038, but the plug assembly 3030 is not axially secured to the pull rod 3038 such that the plug assembly 3030 may remain stationary as the pull rod 3038 is moved through the in-ground pipe 14.

The plug assembly 3030 includes an air valve 3128 to control the pressure in the pressurized zone 3122. The air valve 3128 is fluidly connected to an air tank 3062. As the installation head 3034 moves toward the plug assembly 3030, the pressure inside the pressurized zone 3122 increases. To maintain a constant pressure, or prevent high pressure in the pressurized zone 3122, the air valve 3128 is used to adjust the pressure in the pressurized zone 3122. In some embodiments, the air valve 3128 may automatically release air from the pressurized zone 3122 once the pressure inside the pressurized zone 3122 exceeds a certain pressure limit. In some embodiments, there may be a pressure sensor inside the pressurized zone 3122 that allows a user to monitor the pressure inside the pressurized zone 3122 and control the air valve 3128 as desired.

In the pipe installation system 3010, the pressurized zone 3122 spans a majority of the in-ground pipe 14 between the first end E1 and the second end E2. The installation head 3034 may be used to install the new pipe 18 in sections where a portion, or the entirety, of the in-ground pipe 14 has collapsed.

The installation head 3034 may be an installation head that is similar to the installation head 34 (FIGS. 5-6B), the installation head 1034 (FIG. 9) or the installation head 2034 (FIGS. 10-11). In general, the installation head 3034 includes a leading portion, mating portion, ejection ports, and a grout conduit. In some embodiments, the installation head 3034 may further include fins to split a pipe. In some embodiments, the installation head 3034 further includes a water conduit.

With continued reference to the pipe installation method 3300 includes positioning the pipe installation system 3010 within the in-ground pipe 14 (STEP 3310). Positioning the pipe installation system 3010 in the in-ground pipe 14 includes positioning the plug assembly 3030 and the installation head 3034 in the in-ground pipe 14. The pipe installation system 3010 is positioned such that the plug assembly 3030 is positioned adjacent the second end E2 of the in-ground pipe 14 and the installation head 3034 is positioned adjacent the first end E1 of the in-ground pipe 14.

Once the pipe installation system 3010 is positioned in the in-ground pipe 14, the installation head 3034 may be pulled through a portion of the in-ground pipe 14 (STEP 3320). The installation head 3034 is pulled from the first end E1 of the in-ground pipe 14 to the second end E2 of the in-ground pipe 14 in the pulling direction (shown from left to right in FIG. 13). While the installation head 3034 is being pulled, the plug assembly 3030 remains stationary such that the installation head 3034 is pulled relative to the plug assembly 3030.

The pressurized zone 3122 is created between the plug assembly 3030 and the installation head 3034 (STEP 3330). More specifically, the pressurized zone 3122 is established between the plug assembly 3030 and the maximum cross-section portion of the leading member the installation head 3034. The pressure in the pressurized zone 3122 is monitored such that if the pressure in the pressurized zone 3122 exceeds a pressure limit as the installation head 3034 is moved relative to the plug assembly 3030, air from the pressurized zone 3122 can be adjusted via the air valve 3128.

As the installation head 3034 is being pulled through the in-ground pipe 14, the grout 22 (FIG. 7) is injected into the pressurized zone 3122 (STEP 3340). More specifically, STEP 3340 includes ejecting the grout 22 from the plurality of ejection ports into the pressurized zone 3122.

The pipe installation method 3300 may further include the optional step of bursting the in-ground pipe 14 (STEP 3350). More specifically, the pipe installation method 3300 may further include bursting the in-ground pipe 14 with fins positioned on the leading member of the installation head 3034 as the installation head 3034 is pulled through the in-ground pipe 14. The in-ground pipe 14 is burst in the pressurized zone 3122.

The pipe installation method 3300 also includes positioning the new pipe 18 within the in-ground pipe 14 (STEP 3360). The new pipe 18 is positioned in the grout 22 (FIG. 7) and in the space created by bursting the in-ground pipe 14. Once the new pipe 18 is positioned within in the in-ground pipe 14, the new pipe 18 is separated from the trailing member of the installation head 3034. If the installation head 3034 is similar to the installation head 34, the new pipe 18 may be separated from the pipe fitting by unfastening the fasteners. If the installation head 3034 is similar to the installation head 2034, the new pipe 18 may be separated from the installation head 3034 by severing the joint between the installation head 2034 and the new pipe 18.

Although the method of the pipe installation method 3300 is described in sequential steps, it will be appreciated that some of the steps may be completed in a different order, some of the steps may be completed simultaneously, and some of the steps may be omitted.

Various features of the invention are set forth in the following claims.

What is claimed is:

1. A pipe installation head configured to install a new pipe within an in-ground pipe, the pipe installation head comprising:
a leading portion extending along a central axis, the leading portion having a cross-section including a tapered nose in which the cross-section increases in a rearward direction from a first end to a maximum cross-section portion;
a mating portion rearward of the leading portion, the mating portion configured to mate with the new pipe;
a grout ejection port positioned within the leading portion and configured to eject a grout between an exterior of the pipe installation head and an interior of the in-ground pipe; and
a grout conduit having a connection port configured for attachment with a grout supply line, the grout conduit configured to supply a grout from the connection port to the grout ejection port,
wherein the grout ejection port is positioned no further rearward than the maximum cross-section portion of the leading portion.

2. The pipe installation head of claim 1, wherein the leading portion includes a plurality of radially-projecting fins extending at least partially between the first end of the leading portion and the maximum cross-section portion of the leading portion and configured to burst the in-ground pipe.

3. The pipe installation head of claim 2, wherein the grout ejection port is positioned no further rearward than the plurality of radially-projecting fins.

4. The pipe installation head of claim 2, wherein each radially-projecting fin in the plurality of radially-projecting fins is removably coupled to the leading portion.

5. The pipe installation head of claim 2, further comprising a plurality of bosses positioned around the mating portion, wherein the bosses are offset from the radially-projecting fins.

6. The pipe installation head of claim 1, wherein the grout conduit extends from the mating portion to the leading portion.

7. The pipe installation head of claim 1, wherein the grout ejection port is aimed in a direction that is between a radially outward direction that is perpendicular to the central axis and an axially rearward direction that is parallel to the central axis.

8. The pipe installation head of claim 1, wherein the cross-section of the tapered nose is circular.

9. The pipe installation head of claim 1, wherein the grout ejection port is located where a cross-section of the leading portion is 60% to 100% of a cross-section of the maximum cross-section portion of the leading portion.

10. The pipe installation head of claim 9, wherein the grout ejection port is located where a cross-section of the leading portion is 80% to 95% of the cross-section of the maximum cross-section portion of the leading portion.

11. The pipe installation head of claim 1, wherein the mating portion includes a pipe fitting configured to mate with the new pipe by receiving the new pipe in a pipe receiving space formed therein.

12. The pipe installation head of claim 1, further comprising a plurality of bosses positioned on the mating portion, wherein a first portion of the plurality of bosses are arranged in a first row, wherein a second portion of bosses are arranged in a second row, and wherein the bosses in the first portion are offset from the bosses in the second row.

13. The pipe installation head of claim 1, wherein the pipe installation head is integrally formed.

14. The pipe installation head of claim 1, wherein the leading portion and the mating portion are formed of polymer, the pipe installation head further comprising a metal sheath removably coupled to the leading portion, the metal sheath configured to cover at least a portion of the leading portion.

15. The pipe installation head of claim 14, wherein a tow connection at the first end of the leading portion is configured to secure the metal sheath to the leading portion.

16. A pipe installation system configured to install a new pipe within an in-ground pipe, the system comprising:
a driver assembly including a rod, the driver assembly configured to move at least a portion of the pipe installation system through the in-ground pipe;
a plug assembly positioned on the rod;
an installation head having a leading portion extending along a central axis, a mating portion configured to mate with the new pipe, a grout ejection port positioned within the leading portion, and a grout conduit connected to the grout ejection port, the leading portion having a cross-section including a tapered nose in which the cross-section increases in a rearward direction from a first end to a maximum cross-section portion;
a grout supply line configured to supply a grout to the installation head, the grout supply line attached to the grout conduit by a connection port; and
a coupling assembly positioned between the first end of the leading portion and the plug assembly,
wherein the grout ejection port is positioned no further rearward than the maximum cross-section portion of the leading portion,
wherein a cross-section of the first end of the leading portion is smaller than a cross-section of the plug assembly, and
wherein a cross-section of the maximum cross-section portion of the leading portion is at least as big as the cross-section of the plug assembly.

17. The pipe installation system of claim 16, wherein the leading portion includes a plurality of radially-projecting fins extending at least partially between the first end of the leading portion and the maximum cross-section portion of the leading portion and configured to burst the in-ground pipe.

18. The pipe installation system of claim 17, wherein each fin in the plurality of radially-projecting fins is removably coupled to the leading portion.

19. The pipe installation head of claim 16, wherein the grout conduit extends from the mating portion to the leading portion.

20. The pipe installation system of claim 16, wherein the cross-section of the maximum cross-section portion of the leading portion is larger than the cross-section of the plug assembly.

21. The pipe installation system of claim 16, wherein the plug assembly includes a first disk, a second disk, and an air bag positioned therebetween, and wherein the second disk is coupled to the coupling assembly.

22. The pipe installation system of claim 21, wherein the second disk includes a rubber portion and a hard portion, and wherein the hard portion is coupled to the coupling assembly.

23. The pipe installation system of claim 16, wherein the grout ejection port is aimed in a direction that is between a radially outward direction that is perpendicular to the central axis and an axially rearward direction that is parallel to the central axis.

24. The pipe installation system of claim 16, wherein the grout ejection port is defined by a removeable port plug threaded into an opening in the leading portion.

25. The pipe installation system of claim 16, wherein the mating portion includes a pipe fitting configured to mate with the new pipe by receiving the new pipe in a pipe receiving space formed therein.

26. A pipe installation system configured to install a new pipe within an in-ground pipe, the system comprising:
a plug assembly;
an installation head having a leading portion extending along a central axis, a mating portion configured to mate with the new pipe, a grout ejection port positioned within the leading portion, and a grout conduit connected to the grout ejection port, the leading portion having a cross-section including a tapered nose in which the cross-section increases in a rearward direction from a first end to a maximum cross-section portion;
a driver assembly including a rod, the driver assembly configured to move the installation head through the in-ground pipe;
a grout supply line configured to supply a grout to the installation head, the grout supply line attached to the grout conduit by a connection port; and
wherein the grout ejection port is positioned no further rearward than the maximum cross-section portion of the leading portion,
wherein a cross-section of the first end of the leading portion is smaller than a cross-section of the plug assembly, and
wherein a cross-section of the maximum cross-section portion of the leading portion is at least as big as the cross-section of the plug assembly.

27. The pipe installation system of claim 26, wherein the leading portion includes a plurality of radially-projecting fins extending at least partially between the first end of the leading portion and the maximum cross-section portion of the leading portion and configured to burst the in-ground pipe.

28. The pipe installation system of claim 27, wherein each fin in the plurality of radially-projecting fins is removably coupled to the leading portion.

29. The pipe installation head of claim 26, wherein the grout conduit extends from the mating portion to the leading portion.

30. The pipe installation system of claim 26, wherein the cross-section of the maximum cross-section portion of the leading portion is larger than the cross-section of the plug assembly.

31. The pipe installation system of claim 26, wherein the grout ejection port is aimed in a direction that is between a radially outward direction that is perpendicular to the central axis and an axially rearward direction that is parallel to the central axis.

32. The pipe installation system of claim 26, wherein the grout ejection port is defined by a removeable port plug threaded into an opening in the leading portion.

33. The pipe installation system of claim 26, wherein the mating portion includes a pipe fitting configured to mate with the new pipe by receiving the new pipe in a pipe receiving space formed therein.

34. The pipe installation system of claim 26, wherein the rod extends through the plug assembly.

35. A method of installing a new pipe within an in-ground pipe, the method comprising:
positioning a plug assembly and an installation head in the in-ground pipe, the installation head extending along a central axis and including a leading portion having a tapered nose and a mating portion mated with the new pipe;
driving the installation head in a forward direction through a portion of the in-ground pipe;
creating a pressurized zone between the plug assembly and a maximum cross-section portion of the leading portion of the installation head;
ejecting a grout into the pressurized zone between an exterior of the installation head and an interior of the in-ground pipe, during the driving of the installation head, from a grout ejection port positioned within the leading portion of the installation head; and
positioning the new pipe within in the in-ground pipe.

36. The method of claim 35, wherein driving the installation head through the in-ground pipe includes bursting the in-ground pipe with a plurality of radially-projecting fins positioned on the leading portion of the installation head.

37. The method of claim 35, further comprising driving the plug assembly through the in-ground pipe.

38. The method of claim 35, wherein driving the installation head through the in-ground pipe includes moving the installation head relative to the plug assembly.

39. The method of claim 35, wherein ejecting the grout into the pressurized zone includes ejecting a premixed non-expanding cementitious grout.

40. The method of claim 35, wherein ejecting the grout into the pressurized zone includes ejecting the grout in a direction that is between a radially outward direction that is perpendicular to the central axis and an axially rearward direction that is parallel to the central axis.

41. The method of claim 35, further comprising separating a leading end of the new pipe from the mating portion of the installation head.

42. The method of claim 41, wherein the mating portion includes a pipe fitting configured to mate with the new pipe by receiving the new pipe in a pipe receiving space formed therein, and wherein separating the new pipe includes unfastening fasteners that secure the new pipe in the pipe receiving space.

43. The method of claim 41, wherein separating the new pipe from the mating portion includes severing a fused joint between the leading end of the new pipe and the mating portion of the installation head.

44. The method of claim 35, wherein the grout ejection port is positioned on the leading portion where a diameter of the leading portion is at least as big as an inner diameter of the in-ground pipe.

45. The method of claim 44, wherein driving the installation head through the in-ground pipe includes bursting the in-ground pipe with a plurality of radially-projecting fins positioned on the leading portion of the installation head.

46. The method of claim 35, wherein the mating portion includes a plurality of bosses positioned on the mating portion, the plurality of bosses configured to push the grout radially outward.
